(19) United States
(12) Patent Application Publication
(10) Pub. No.: US 2026/0223054 A1
(43) Pub. Date: Jul. 30, 2026

(54) USER EQUIPMENT AND METHOD FOR PERFORMING SIDELINK POSITIONING WITHOUT SIDELINK POSITIONING PROTOCOL SESSION

(71) Applicant: LENOVO (BEIJING) LIMITED, Beijing (CN)

(72) Inventors: Jing HAN, Beijing (CN); Jie HU, Beijing (CN); Luning LIU, Beijing (CN); Lihua YANG, Beijing (CN); Haiming WANG, Beijing (CN)

(21) Appl. No.: 19/148,528

(22) PCT Filed: Jan. 17, 2023
(86) PCT No.: PCT/CN2023/072709

§ 371 Date: Jul. 16, 2025

(51) Int. Cl. H04W 64/00; H04W 92/18

(52) U.S. Cl. CPC H04W 64/00; H04W 92/18

(57) ABSTRACT

The present application relates to a first UE and a method for performing session-less sidelink positioning. The method includes: receiving, by the first UE, a location request; receiving, by the first UE, at least one assistance data from the at least one second UE; and determining, by the first UE, a position information for the at least one second UE according to the at least one assistance data.

### TECHNICAL FIELD

Embodiments of the present application generally relate to wireless communication technology, especially to a user equipment and a method for performing sidelink positioning without sidelink positioning protocol session under 3GPP (3rd Generation Partnership Project) 5G new radio (NR).

### BACKGROUND

With network developments of 3rd Generation Partnership Project (3GPP) 5G New Radio (NR), sidelink transmission between user equipment (UE) is developed. For some positioning purposes, sidelink positioning protocol (SLPP) is introduced in sidelink transmission. However, specific details of some scenarios applying SLPP, such as multiple UEs in the same positioning group need to perform sidelink positioning, have not been discussed yet and there are still some issues that need to be solved.

### SUMMARY

Some embodiments of the present application provide a first user equipment (UE). The first UE includes a processor and a transceiver coupled to the processor. The processor is configured to perform a sidelink positioning in a positioning group, which includes the first UE and at least one second UE, without sidelink positioning protocol (SLPP) session by: receiving a location request; receiving, via the transceiver, at least one assistance data from the at least one second UE; and determining a position information for the at least one second UE according to the at least one assistance data.

Some embodiments of the present application provide a first UE. The first UE includes a processor and a transceiver coupled to the processor. The first UE includes a processor and a transceiver coupled to the processor. The processor is configured to perform a sidelink positioning in a positioning group, which includes the first UE and at least one second UE, without SLPP session by: determining at least one assistance data; and transmitting, via the transceiver, the at least one assistance data to the at least one second UE for the at least one second UE to determine a position information.

Some embodiments of the present application provide a method for a first UE to perform a sidelink positioning in a positioning group without SLPP session. The method includes: receiving, by the first UE, a location request corresponding to the positioning group, wherein the positioning group includes the first UE and at least one second UE; receiving, by the first UE, at least one assistance data from the at least one second UE; and determining, by the first UE, a position information for the at least one second UE according to the at least one assistance data.

Some embodiments of the present application provide a method for a first UE to perform a sidelink positioning in a positioning group without SLPP session. The method includes: determining, by the first UE, at least one assistance data; and transmitting, by the first UE, the at least one assistance data to at least one second UE for the at least one second UE to determine a position information.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates a schematic diagram of message transmission in accordance with some embodiments of the present application.

FIG. 3 illustrates a schematic diagram of message transmission in accordance with some embodiments of the present application.

FIG. 4 illustrates a flow chart of a method for a UE to perform a sidelink positioning in a positioning group in accordance with some embodiments of the present application.

FIG. 5 illustrates a flow chart of a method for a UE to perform a sidelink positioning in a positioning group in accordance with some embodiments of the present application.

FIG. 6 illustrates a flow chart of a method for a UE to perform a sidelink positioning in a positioning group in accordance with some embodiments of the present application.

FIG. 7 illustrates a flow chart of a method for a UE to perform a sidelink positioning in a positioning group in accordance with some embodiments of the present application.

FIG. 8 illustrates a block diagram of an exemplary UE in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), etc. It is contemplated that along with the 3GPP and related communication technology development, the terminologies recited in the present application may change, which should not affect the principle of the present application.

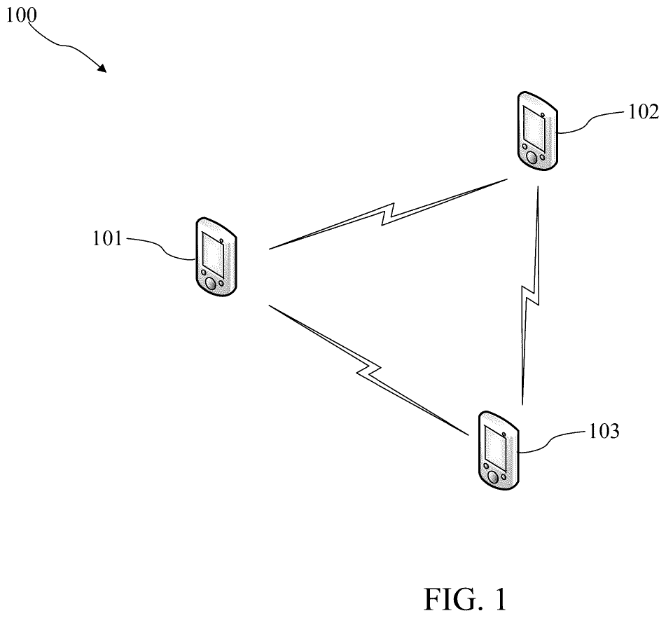

FIG. 1 illustrates a schematic diagram of a wireless communication system 100 in accordance with some embodiments of the present application. The wireless communication system 100 includes a plurality of user equipment (UEs) 101, 102 and 103. Although a specific number of UEs 101, 102 and 103 are depicted in FIG. 1, it is contemplated that any number of UE, base station (BS) and core network (CN) may be included in the wireless communication system 100.

UEs 101, 102 and 103 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, UEs 101, 102 and 103 may include, for example, but is not limited to, a portable wireless communication device, a smart phone, a cellular telephone, a flip phone, a device having a subscriber identity module, a personal computer, a selective call receiver, a wireless sensor, a monitoring device, or any other device that is capable of sending and receiving communication signals on a wireless network.

In some embodiments of the present application, UEs 101, 102 and 103 may include, for example, but is not limited to, wearable devices, such as smart watches, fitness bands, optical head-mounted displays, or the like. Moreover, UEs 101, 102 and 103 may be referred to as a subscriber unit, a mobile, a mobile station, a user, a terminal, a mobile terminal, a wireless terminal, a fixed terminal, a subscriber station, a user terminal, or a device, or described using other terminology used in the art. UEs 101, 102 and 103 may communicate with each other via sidelink transmission.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

According to existing agreements, sidelink positioning protocol (SLPP) is introduced in sidelink transmission. However, specific details of some scenarios applying SLPP, such as multiple UEs in the same positioning group need to perform sidelink positioning, have not been discussed yet and there are still some issues that need to be solved.

Accordingly, in the present disclosure, performing sidelink positioning, especially performing sidelink positioning without establishing session (i.e., performing session-less sidelink positioning) in a positioning group, may be introduced. More details on embodiments of the present disclosure will be further described hereinafter.

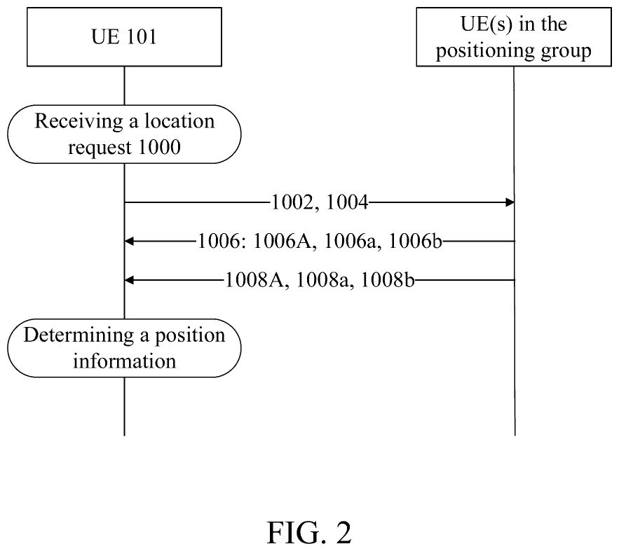

FIG. 2 is a schematic diagram of message transmission in accordance with some embodiments of the present application. In some embodiments, in a positioning group of multiple UEs, UE 101 may need to perform sidelink positioning without session and UE 101 may be a target UE which needs to calculate position or ranging. In particular, to perform sidelink positioning without SLPP session, UE 101 may: (1) receive a location request 1000; (2) transmit (e.g., groupcast/broadcast) at least one of a capability message 1002 and a location service quality of service (QoS) requirement 1004 to UE(s) in the positioning group; (3) receive at least one assistance data 1006 from UE(s) in the positioning group; and (4) determine a position information for UE(s) in the positioning group according to the at least one assistance data 1006.

In some implementations, the location request 1000 may be transmitted from: (1) an upper layer (e.g., an application layer), which is associated with the positioning group with a group layer-2 identification, of UE 101; or (2) an initiator UE (e.g., UE 102 or 103) in the positioning group, such as a leader of the positioning group. The location request 1000 may include a location service quality of service (QoS) requirement.

In some implementations, the sidelink positioning without SLPP session may be performed according to different conditions. In some cases, the location request 1000 indicates to UE 101 that the sidelink positioning should be performed without SLPP session. In some cases, the positioning group is preconfigured for the UE(s) included therein to perform the sidelink positioning without SLPP session. In other words, (1) an indication of the location request 1000 may indicates UE 101 to perform the SLPP session-less sidelink positioning; or (2) the positioning group (or the group layer-2 identification of the positioning group) may be preconfigured to associate with the sidelink positioning without SLPP session so that the UE(s), such as UE 101, in the positioning group may perform the sidelink positioning without SLPP session.

In some implementations, transmitting the capability message 1002 and/or the location service QoS requirement 1004 to UE 102 may be optionally performed. The capability message 1002 may include bandwidth, location method and/or location configuration supported by UE 101. The location method may include: (1) round trip time (RTT) type solutions using sidelink; (2) sidelink-angles of arrival (SL-AoA); (3) sidelink-time difference of arrival (SL-TDOA); or (4) sidelink-angles of departure (SL-AoD), which are defined in 3GPP specification. The capability message 1002 may refer to sidelink positioning and protocol capabilities related to SLPP and the positioning methods supported by SLPP, which may include common capabilities (e.g., information of segmentationInfo defined in 3GPP specification) and specific capabilities per supported positioning methods (e.g., information of sidelink positioning reference signal (SL-PRS) related capability, measurement and reporting related capability defined in 3GPP specification).

In some implementations, the capability message 1002 and/or the location service QoS requirement 1004 may be transmitted (groupcasted) by a trigger, and the trigger includes: (1) a reception of the location request 1000; (2) a change of member in the positioning group, such as UE 101 joins in the positioning group or new UE joins in the positioning group; (3) a timer (e.g., a periodical timer); or (4) an information of that UE 101 has not received any assistance data in a time period.

In some implementations, the at least one assistance data 1006 may be received from UE 102 by a trigger, and the trigger includes: (1) a reception of the location request 1000; (2) a transmission of the capability message 1002 and/or the location service QoS requirement; (3) a change of member in the positioning group, such as new UE joins in the positioning group; or (4) a timer (e.g., a periodical timer).

In some implementations, the at least one assistance data 1006 may include a plurality of assistance data 1006A. UE 101 may determine that the plurality of assistance data 1006A are associated with an identification of UE 102, which means that the plurality of assistance data 1006A may be transmitted from the same UE 102.

In some cases, UE 101 may determine a specific assistance data 1006A, which satisfies a requirement of UE 101, from the plurality of assistance data 1006A and store the specific assistance data 1006A for UE 102. More specifically, UE 101 is capable of performing sidelink positioning with a condition (e.g., a bandwidth, a positioning method, etc.). After receiving the plurality of assistance data 1006A, UE 101 determines that the specific assistance data 1006A of the plurality of assistance data 1006A satisfies the condition (e.g., supports the bandwidth, the positioning method, etc.). Therefore, UE 101 stores the specific assistance data 1006A for UE 102.

In some cases, UE 101 may determine that none of the plurality of assistance data 1006A satisfies the requirement of UE 101 (i.e., the plurality of assistance data 1006A fail to satisfy the requirement of UE 101). Then, UE 101 may transmit a capability message, a location request or a location service QoS requirement to UE 102. More specifically, UE 101 may determines that none of the plurality of assistance data 1006A satisfies the requirement of UE 101 when: (1) UE 101 has not transmitted any capability message, location request or location service QoS requirement in the positioning group before; (2) UE 101 has not transmitted any capability message, location request or location service QoS requirement in the positioning group during a time period; or (2) UE 101 has not transmitted any capability message, location request or location service QoS requirement in the positioning group to UE 102 after UE 102 joins the positioning group. Then, UE 101 may transmit the capability message, the location request or the location service QoS requirement to UE 102.

In some implementations, UE 101 may measure at least one sidelink positioning reference signal (SL-PRS) 1008A transmitted from UE 102 according to the stored assistance data 1006A. The, UE 101 may determine the position information for UE 102 according to the measurement result of the at least one SL-PRS 1008A.

In some implementations, the at least one assistance data 1006 may include an assistance data 1006a and an assistance data 1006b. UE 101 may determine that the assistance data 1006a is associated with an identification of UE 102 and the assistance data 1006b is associated with an identification of UE 103, which means that the assistance data 1006a may be transmitted from UE 102 and the assistance data 1006b may be transmitted from UE 103. Then, UE 101 may respectively store the assistance data 1006a for UE 102 and store the assistance data 1006b for UE 103 by the identifications of UE 102 and 103.

In some implementations, UE 101 may measure at least one SL-PRS 1008a transmitted from UE 102 according to the stored assistance data 1006a and measure at least one SL-PRS 1008b transmitted from UE 103 according to the stored assistance data 1006b. The, UE 101 may determine the position information for UE 102 according to the measurement result of the at least one SL-PRS 1008a and determine the position information for UE 103 according to the measurement result of the at least one SL-PRS 1008b.

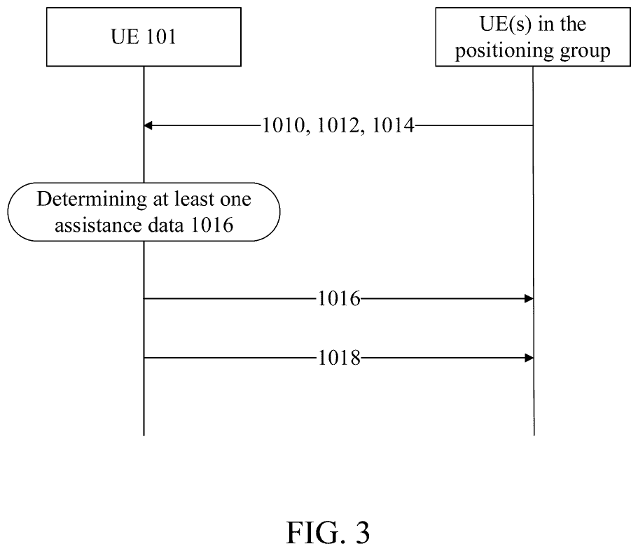

FIG. 3 is a schematic diagram of message transmission in accordance with some embodiments of the present application. In some embodiments, in a positioning group of multiple UEs, UE 101 may need to perform sidelink positioning without session and UE 101 may be an anchor UE which assists a target UE to calculate position or ranging. In particular, to perform sidelink positioning without SLPP session, UE 101 may: (1) receive at least one of a capability message(s) 1010, a location request(s) 1012 and a location service QoS requirement(s) 1014 from the UE(s) in the positioning group; (2) determine at least one assistance data 1016; and (3) transmit (e.g., groupcast/broadcast) the at least one assistance data 1016 to the UE(s) in the positioning group for the UE(s) to determine a position information.

In some implementations, receiving the capability message(s) 1010, the location request(s) 1012 and/or the location service QoS requirement(s) 1014 from the UE(s) in the positioning group may be optionally performed. The capability message(s) 1010, the location request(s) 1012 and/or the location service QoS requirement(s) 1014 may be received by a trigger, and the trigger includes: (1) a reception of a location request or an assist location indication from an upper layer (e.g., application layer) of UE 101 while the assist location indication from the upper layer indicates UE 101 to perform the sidelink positioning as an anchor UE; (2) a change of member in the positioning group, such as UE 101 joins in the positioning group or new UE joins in the positioning group; (3) a timer (e.g., a periodical timer); or (4) a UE type (e.g., type of road side unit) of UE 101.

In some implementations, the at least one assistance data 1016 may be determined by a trigger, and the trigger includes: (1) a reception of a location request or an assist location indication from an upper layer (e.g., application layer) of UE 101 while the assist location indication from the upper layer indicates UE 101 to perform the sidelink positioning as an anchor UE; (2) a change of member in the positioning group, such as UE 101 joins in the positioning group or new UE joins in the positioning group; (3) a timer (e.g., a periodical timer); (4) a reception of the capability message 1010, the location request 1012 and/or the location service QoS requirement 1014; or (5) the UE type (e.g., type of road side unit) of UE 101.

In some implementations, UE 101 may determine a specific set of the at least one assistance data 1016 for UE(s) according to the capability message(s) 1010, the location request(s) 1012 and/or the location service QoS requirement(s) 1014. More specifically, UE 101 may receive the capability messages 1010, the location requests 1012 and/or the location service QoS requirements 1014 from the UEs in the positioning group. Then, UE 101 may determines the specific set of the at least one assistance data 1016 while the specific set fulfills the most stringent QoS satisfying all received capability messages 1010, location requests 1012 and/or location service QoS requirements 1012. UE 101 may transmit the specific set of the at least one assistance data 1016 to the UEs (i.e., target UEs) in the positioning group for all of the UEs to determine the position information.

In some implementations, UE 101 may not determine the specific set of the at least one assistance data 1016 for UE(s) according to the capability message(s) 1010, the location request(s) 1012 and/or the location service QoS requirement(s) 1014 because there is no assistance data 1016 fulfills the most stringent QoS satisfying all received capability messages 1010, location requests 1012 and/or location service QoS requirements 1012. Then, UE 101 may determine multiple sets of the at least one assistance data 1016 for different UEs in the positioning group, and each set of the at least one assistance data 1016 may fulfill the QoS satisfying received capability message 1010, location request 1012 and/or location service QoS requirement 1012 from the corresponding UE in the positioning group.

In some implementations, the multiple sets of the at least one assistance data 1016 are associated with multiple priorities of capabilities, which may be included in the capability messages 1010 or location service QoS requirements 1014 of difference UEs in the positioning group.

In some implementations, when UE 101 has not received the capability message(s) 1010, the location request(s) 1012 and/or the location service QoS requirement(s) 1014 from the UE(s) in the positioning group, UE 101 may determine the at least one assistance data 1016 according to a capability of UE 101 or a default configuration used for assistance data.

In some implementations, when UE 101 has not received the capability message(s) 1010, the location request(s) 1012 and/or the location service QoS requirement(s) 1014 from the UE(s) in the positioning group during a timer period after: (1) receiving the location request or the assist location indication from an upper layer (e.g., application layer) of UE 101; (2) the change of member in the positioning group, such as UE 101 joins in the positioning group or new UE joins in the positioning group; or (3) the timer (e.g., the periodical timer); or (4) the UE type (e.g., type of road side unit) of UE 101, UE 101 may determine the at least one assistance data 1016 according to the capability of UE 101 or the default configuration used for assistance data.

In some implementations, the at least one assistance data 1016 may be transmitted (e.g., groupcasted/broadcasted) to the UE(s) in the positioning group by a trigger, and the trigger includes: (1) the reception of the location request or the assist location indication from the upper layer (e.g., application layer) of UE 101 while the assist location indication from the upper layer indicates UE 101 to perform the sidelink positioning as an anchor UE; (2) the change of member in the positioning group, such as UE 101 joins in the positioning group or new UE joins in the positioning group; (3) the timer (e.g., the periodical timer); (4) the reception of the capability message 1010, the location request 1012 and/or the location service QoS requirement 1014; (5) a determination of the at least one assistance data 1016; or (6) the UE type (e.g., type of road side unit) of UE 101.

In some implementations, UE 101 may transmit at least one SL-PRS 1018 to the UE(s) in the positioning group according to the at least one assistance data 1016 so that the UE(s) in the positioning group may measure the at least one SL-PRS 1018 to determine the position information.

In some implementations, the at least one SL-PRS 1018 may be stopped being transmitted by a trigger, and the trigger includes: (1) an upper layer indication; (2) a timer (e.g., the periodical timer); or (3) an information of reaching a pre-configured stop timing.

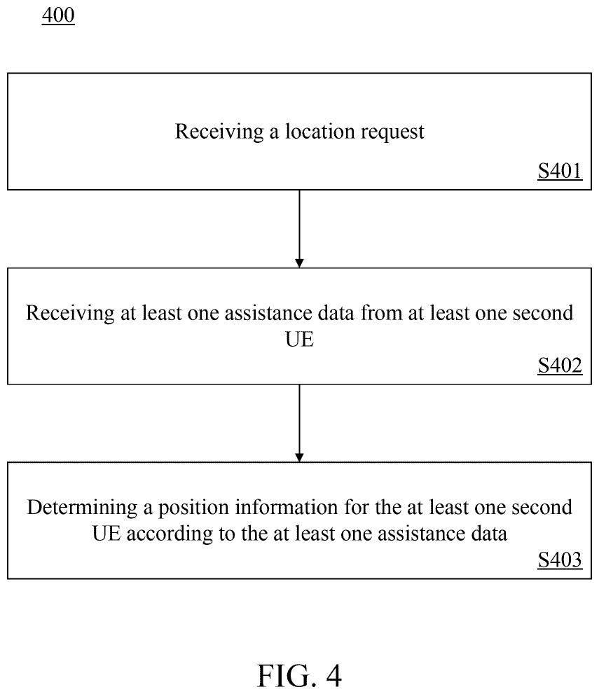

FIG. 4 illustrates a flow chart of a method for a first UE to perform a sidelink positioning in a positioning group, which includes the first UE and at least one second UE, without session in accordance with some embodiments of the present application. Referring to FIG. 4, method 400 is performed by the first UE (e.g., UE 101 as a target UE) in some embodiments of the present application.

In some embodiments, operation S401 is executed to receive, by the first UE, a location request. Operation S402 is executed to receive, by the first UE, at least one assistance data from the at least one second UE. Operation S403 is executed to determine, by the first UE, a position information for the at least one second UE according to the at least one assistance data.

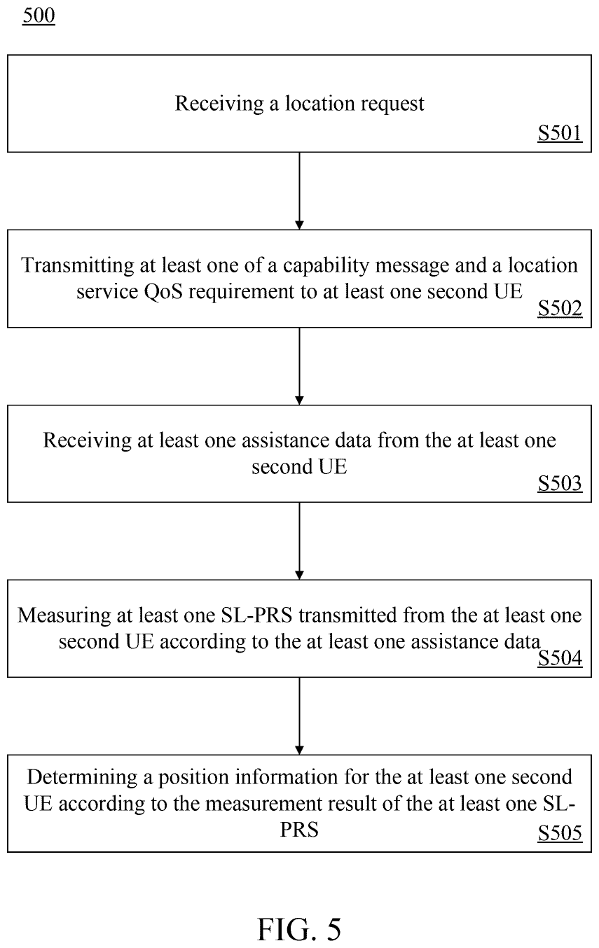

FIG. 5 illustrates a flow chart of a method for a first UE to perform a sidelink positioning in a positioning group, which includes the first UE and at least one second UE, without session in accordance with some embodiments of the present application. Referring to FIG. 5, method 500 is performed by the first UE (e.g., UE 101 as a target UE) in some embodiments of the present application.

In some embodiments, operation S501 is executed to receive, by the first UE, a location request. Operation S502 is executed to transmit, by the first UE, at least one of a capability message and a location service QoS requirement to the at least one second UE in the positioning group. Operation S503 is executed to receive, by the first UE, at least one assistance data from the at least one second UE. Operation S504 is executed to measure, by the first UE, at least one SL-PRS transmitted from the at least one second UE according to the at least one assistance data. Operation S505 is executed to determine, by the first UE, a position information for the at least one second UE according to the measurement result of the at least one at least one SL-PRS.

In some embodiments, operation S502 may be optionally executed. In some embodiments, operations S502 and S503 may be simultaneously executed

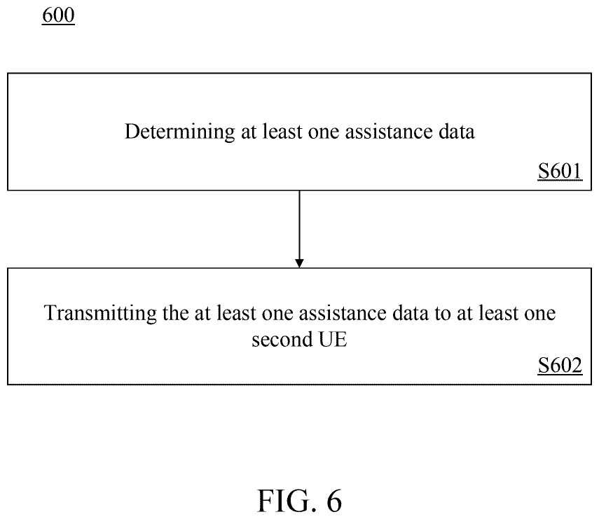

FIG. 6 illustrates a flow chart of a method for a first UE to perform a sidelink positioning in a positioning group, which includes the first UE and at least one second UE, without session in accordance with some embodiments of the present application. Referring to FIG. 6, method 600 is performed by the first UE (e.g., UE 101 as an anchor UE) in some embodiments of the present application.

In some embodiments, operation S601 is executed to determine, by the first UE, at least one assistance data. Operation S602 is executed to transmit, by the first UE, the at least one assistance data to the at least one second UE for the at least one second UE to determine a position information.

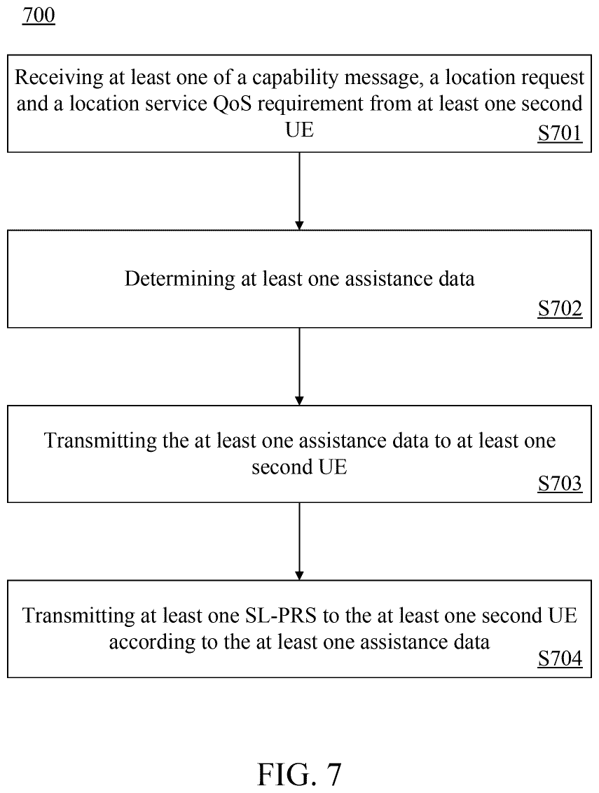

FIG. 7 illustrates a flow chart of a method for a first UE to perform a sidelink positioning in a positioning group, which includes the first UE and at least one second UE, without session in accordance with some embodiments of the present application. Referring to FIG. 7, method 700 is performed by the first UE (e.g., UE 101 as an anchor UE) in some embodiments of the present application.

In some embodiments, operation S701 is executed to receive, by the first UE, at least one of a capability message, a location request and a location service QoS requirement from the at least one second UE in the positioning group. Operation S702 is executed to determine, by the first UE, at least one assistance data. Operation S703 is executed to transmit, by the first UE, the at least one assistance data to the at least one second UE. Operation S704 is executed to transmit, by the first UE, at least one SL-PRS to the at least one second UE according to the at least one assistance data for the at least one second UE to determine a position information. In some embodiments, operation S701 may be optionally executed.

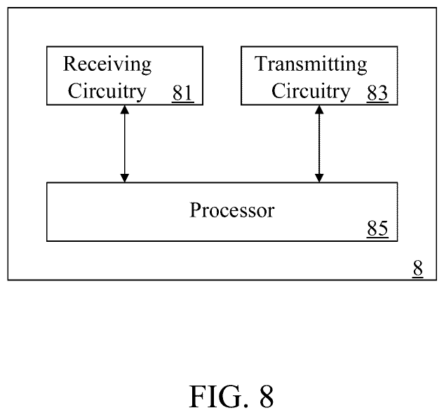

FIG. 8 illustrates an example block diagram of a UE 8 according to an embodiment of the present disclosure.

As shown in FIG. 8, the UE 8 may include at least one non-transitory computer-readable medium (not illustrated in FIG. 8), a receiving circuitry 81, a transmitting circuitry 83, and a processor 85 coupled to the non-transitory computer-readable medium (not illustrated in FIG. 8), the receiving circuitry 81 and the transmitting circuitry 83.

Although in this figure, elements such as processor 85, transmitting circuitry 83, and receiving circuitry 81 are described in the singular, the plural is contemplated unless limitation to the singular is explicitly stated. In some embodiments of the present disclosure, the receiving circuitry 81 and the transmitting circuitry 83 are combined into a single device, such as a transceiver. In certain embodiments of the present disclosure, the UE 8 may further include an input device, a memory, and/or other components.

In some embodiments of the present disclosure, the non-transitory computer-readable medium may have stored thereon computer-executable instructions to cause a processor to implement the method with respect to the user equipment as described above. For example, the computer-executable instructions, when executed, cause the processor 85 interacting with receiving circuitry 81 and transmitting circuitry 83, so as to perform the operations with respect to UE depicted in FIGS. 1 to 3.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A first user equipment (UE) for wireless communication, comprising:
at least one memory; and
at least one processor coupled with the at least one memory and configured to cause the first UE to:
receive a location request within a positioning group of multiple UEs for performing a sidelink positioning without a session, wherein the multiple UEs include the first UE and at least one second UE;
receive at least one assistance data from the at least one second UE; and
determine position information for the at least one second UE according to the at least one assistance data.

2. The first UE of claim 1, wherein the location request is received from an upper layer of the first UE or received from an initiator UE of the positioning group.

3. The first UE of claim 1, wherein the location request indicates to the first UE that the sidelink positioning is performed without a sidelink positioning protocol (SLPP) session, or the positioning group is preconfigured for the first UE to perform the sidelink positioning without the SLPP session.

4. The first UE of claim 1, wherein the at least one processor is further configured to cause the first UE to:
transmit a capability message or a location service quality of service (QoS) requirement according to a trigger including:
a reception of the location request;
a change of member in the positioning group;
a timer; or
information that the first UE has not received any assistance data in a time period.

5. The first UE of claim 1, wherein the at least one assistance data is received from the at least one second UE according to a trigger including:
a reception of the location request;
a transmission of at least one of a capability message and a location service quality of service (QoS) requirement;
a change of member in the positioning group; or
a timer.

6. The first UE of claim 1, wherein the at least one processor is further configured to cause the first UE to:
determine that a first assistance data of the at least one assistance data fails to satisfy a requirement of the first UE;
transmit a capability message, a location request, or a location service quality of service (QoS) requirement.

7. The first UE of claim 1, wherein the at least one processor is further configured to cause the first UE to:
measure at least one sidelink positioning reference signal (SL-PRS) transmitted from the at least one second UE according to the at least one assistance data; and
determine the position information for the at least one second UE according to the measurement result of the at least one SL-PRS.

8. A first user equipment (UE) for wireless communication, comprising:
at least one memory; and
at least one processor coupled with the at least one memory and configured to cause the first UE to:
determine at least one assistance data for perform a sidelink positioning in a positioning group, which includes the first UE and at least one second UE, without a session; and
transmit the at least one assistance data to the at least one second UE for the at least one second UE to determine a position information.

9. The first UE of claim 8, wherein the at least one assistance is determined according to a trigger including:
a reception of a location request or an assist location indication from an upper layer of the first UE, wherein the assist location indication from the upper layer indicates the first UE to perform the sidelink positioning as an anchor UE;
a change of member in the positioning group;
a timer;
a reception of at least one of a capability message, a location request, and a location service quality of service (QoS) requirement from the at least one second UE; or
a UE type of the first UE.

10. The first UE of claim 8, wherein the at least one processor is further configured to cause the first UE to:
receive at least one of a capability message, a location request, and a location service quality of service (QoS) requirement from the at least one second UE; and
determine a specific set of the at least one assistance data according to the at least one of the capability message, the location request, and the location service QoS requirement.

11. The first UE of claim 8, wherein the at least one processor is further configured to cause the first UE to:
determine multiple sets of the at least one assistance data for different UEs in the positioning group;
wherein the multiple sets of the at least one assistance data are associated with multiple priorities of capabilities or location service quality of service (QoS) requirements of the different UEs in the positioning group.

12. The first UE of claim 8, wherein the at least one assistance data is determined according to capability of the first UE or default configuration without receiving a capability message, a location request, or a location service quality of service (QoS) requirement in the positioning group.

13. The first UE of claim 8, wherein the at least one assistance data is transmitted according to a trigger including:
a reception of a location request or an assist location indication from an upper layer of the first UE, wherein the assist location indication from an upper layer indicates the first UE to perform the sidelink positioning as an anchor UE;
a change of member in the positioning group;
a timer;
a reception of at least one of a capability message, a location request, and a location service quality of service (QoS) requirement from the at least one second UE;
a determination of the at least one assistance data; or
a UE type of the first UE.

14. The first UE of claim 8, wherein the at least one processor is further configured to cause the first UE to:
Transmit at least one sidelink positioning reference signal (SL-PRS) to the at least one second UE according to the at least one assistance data.

15. The first UE of claim 14, wherein the transmission of the at least one SL-PRS is stopped according to a trigger including:
an upper layer indication;
a timer; or
an information of reaching a pre-configured stop timing.

16. A method performed by a first user equipment (UE), the method comprising:
receiving a location request within a positioning group of multiple UEs for performing a sidelink positioning without a session, wherein the multiple UEs include the first UE and at least one second UE;
receiving at least one assistance data from the at least one second UE; and
determining a position information for the at least one second UE according to the at least one assistance data.

17. The method of claim 16, wherein the location request is received from an upper layer of the first UE or received from an initiator UE of the positioning group.

18. The method of claim 16, wherein the location request indicates to the first UE that the sidelink positioning is performed without a sidelink positioning protocol (SLPP) session, or the positioning group is preconfigured for the first UE to perform the sidelink positioning without the SLPP session.

19. The method of claim 16, further comprising:
transmitting a capability message or a location service quality of service (QoS) requirement according to a trigger including:
a reception of the location request;
a change of member in the positioning group;
a timer; or
information that the first UE has not received any assistance data in a time period.

20. A method performed by a first user equipment (UE), the method comprising:
determining assistance data for performing a sidelink positioning in a positioning group without a session,
wherein the positioning group includes the first UE and a second UE; and
transmitting the assistance data to the second UE.
